(19) United States
(12) Patent Application Publication
(10) Pub. No.: US 2002/0051533 A1
(43) Pub. Date: May 2, 2002

(54) Ergonomic apparatus for increasing safety during usage of a cellular telephone handset or hands-free kit

(76) Inventors: Guy Edelist, Rinatia (IL); Oleg Kirichencko, Petach tikva (IL); Shmuel Melman, Tel Aviv (IL); Alik Nagel, Solana Beach, CA (US)

Correspondence Address: Law Offices of Mark D. Wieczorek, P.O. Box 70072, San Diego, CA, 92167, US

(21) Appl. No.: 09/828,552

(22) Filed: Apr. 6, 2001

Related U.S. Application Data
(60) Provisional application No. 60/195,603, filed on Apr. 6, 2000.
(60) Provisional application No. 60/211,842, filed on Jun. 15, 2000.

(51) Int. Cl. H04M 1/00

(52) U.S. Cl. 379/441

(57) ABSTRACT

An apparatus and method for enhancing safety during usage of a hands-free kit of a cellular telephone, including a boot with a sleeve into which the earphone of a hands-free kit may be inserted, a sound tube acoustically coupled to the boot, and an earpiece acoustically coupled to the sound tube.

### FIELD OF THE INVENTION

The present invention relates to accessories for handsets employing electronics, and more particularly to accessories for handsets for increasing the safety during usage thereof and for increasing their ergonomic value.

### BACKGROUND OF THE INVENTION

It is widely accepted that cellular telephones have vastly increased the convenience of telecommunications. Such telephones allow communications wirelessly from and to practically any point on the globe.

However, due to the small size of such cellular telephones, the same lack various ergonomic characteristics. In addition, their small size and convenience make the same a large temptation to use when driving or when performing other activities requiring attention. The same may be true of radiophones, walkie-talkies, and other such devices. While the same may be used while driving or performing these activities, it is accepted that such action may occasionally be dangerous.

Furthermore, there is a current concern among the medical community that electronic handsets, such as those employed by cellular telephones, are creating a hazardous amount of violent radiation while they are in use.

A proposed solution to this was the “hands-free” kit. In such a system, the body of the cellular telephone is kept away from the user. In this way, the radiation was intended to be minimized. However, at least by April of 2000, various press and media informed the public of findings that indicated the use of hands-free kits could be as dangerous, or even more dangerous, than a user holding the phone directly to their ear.

Various devices have been proposed that may purport to remedy this deficiency. For example, U.S. Pat. No. 5,528,689, issued Jun. 18, 1996 to Chan, discloses an apparatus for converting a hand-held telephone into a headset telephone. The device includes a headset for coupling an individual's ear and mouth to a pair of sound tubes. The sound tubes extend from the headset to removably couple with a hand-held telephone, whereby sound is transmitted between the headset and the telephone through the sound tubes. The patent states that it serves to place the cellular phone a greater distance from the user's head to reduce exposure to potentially hazardous radiation generated by the cellular phone.

Similarly, U.S. Pat. No. 5,613,22, issued Mar. 18, 1997, to Guenther discloses a headset for use with a cellular telephone. The headset includes an acoustical earpiece assembly adapted for the acoustical transmission of sound to the ear and a flexible acoustical tube connected to the earpiece assembly and to an acoustical receiving cup. The headset also includes a device for attaching the acoustical receiving cup to a telephone in a position where the mouth of the cup is disposed closely adjacent the telephone speaker for receiving sound emitting from the speaker. The acoustical cup transmits sound to the earpiece assembly via the acoustical receiving tube. The earpiece assembly has a transmitter mechanism for picking up sounds made by a person wearing the headset, and for transmitting such sounds to the transmitter of the telephone.

U.S. Pat. No. 4,090,042, issued May 16, 1978, to Larkin, as well as his later U.S. Pat. No. 4,118,606, disclose a detachable communications headset that is described to be “all acoustic”, including a transmitter tube and a receiver tube. The transmitter and receiver tubes are detachably coupled to communications equipment remote from the headset. The electronic components used for radio and telephone communications are thus remote from the user's head.

Other patents that may be considered in this field include U.S. Pat. No. 6,181,801; U.S. Pat. No. 3,667,569; U.S. Pat. No. 3,851,123; and U.S. Pat. No. 3,993,161.

However, none of the above references discloses a device that is ergonomic. Moreover, none of the above references discloses a device that allows for amplification. Further, none removes the electronics from a handset, in the vicinity of the user's head, in a simple way.

### SUMMARY OF THE INVENTION

The present invention overcomes the disadvantages of the prior art noted above.

In one aspect, the invention is directed towards an adaptor for enhancing safety during usage of a mobile communications unit, including: an adaptor box including a plug to insert in an input/output port of a mobile communications unit; a sound tube acoustically coupled to the adaptor box; and a communications port acoustically coupled to the sound tube, wherein the communications port is a microphone port or a speaker port.

Implementations of the invention may include one or more of the following. The communications port may be a speaker port, and may further include another sound tube acoustically coupled to the adaptor box, and a communications port acoustically coupled to the another sound tube, wherein the communications port is a microphone port and a speaker port. The communications port may be a speaker port, and may further comprise a microphone wire coupled to the adaptor box, and a microphone coupled to the microphone wire.

In another aspect, the invention is directed to an adaptor for enhancing safety during usage of a mobile communications unit, including a microcontroller amplifier including a plug to insert in an input/output port of a mobile communications unit; a sound tube acoustically coupled to the microcontroller amplifier; and a communications port acoustically coupled to the sound tube, wherein the communications port is a microphone port or a speaker port.

Implementation of the invention may include one or more of the following. The communications port may be a speaker port, and may further include another sound tube acoustically coupled to the microcontroller amplifier; and a communications port acoustically coupled to the another sound tube, wherein the communications port is a microphone port and a speaker port.

In another aspect, the invention is directed to a method for enhancing safety during usage of a mobile communications unit, including providing an adaptor box, the adaptor box having a sound tube acoustically coupled to the adaptor box, and a communications port acoustically coupled to the sound tube, wherein the communications port is a microphone port or a speaker port. The adaptor box is plugged into an input/output port of a mobile communications unit.

In another aspect, the invention is directed to an adaptor for enhancing safety during usage of a mobile communications unit, including a boot with a sleeve in which the earphone of a hands-free kit may be inserted; a sound tube acoustically coupled to the boot; and an earpiece acoustically coupled to the sound tube.

Implementation of the invention may include one or more of the following. The boot may include an acoustical cavity for improving the quality of or increasing the volume of sound exiting the earphone and entering the sound tube. The acoustical cavity may be a single cavity or may include a first cavity separated from a second cavity by an orifice. The orifice may have a size that is a percentage of the diameter of the first or second cavity. The boot may be made of a compliant material such as a polymer. The earpiece may also include an acoustical cavity for improving the quality of or increasing the volume of sound, and the same may be a single or double cavity.

In another aspect, the invention is directed to a method for enhancing safety during usage of a mobile communications unit, including providing a boot with a sleeve in which an earphone of a hands-free kit may be inserted, providing a sound tube acoustically coupled to the boot, providing an earpiece acoustically coupled to the sound tube, and inserting an earphone of a hands-free kit into the sleeve of the boot.

Advantages of the invention may include one or more of the following. A device according to the invention may allow for easy amplification of the transmitted sound. A device according to the invention may be pleasingly ergonomic. The device may achieve substantial isolation of the user's brain from electromagnetic radiation in a simple way.

Other advantages will be apparent from the description that follows, including the figures and the claims.

### BRIEF DESCRIPTION OF THE DRAWINGS

FIG. 1 is a schematic diagram of an adapter connected to the cellular handset according to an embodiment of the present invention. A set of two tubes are connected to the adapter; one for each direction of transmitted voice or sound;

FIG. 2 is a schematic diagram of an adapter connected to the cellular handset according to another embodiment of the present invention. A tube is connected to the adapter to transmit the received voice or sound signal. A microphone and accompanying microphone wire are used for transmitting voice or sound; and

FIG. 3 is a schematic diagram of an adapter connected to the cellular handset according to another embodiment of the present invention-a micro-controller/amplifier apparatus is connected to the cellular handset hands-free jack—the tubes and/or microphone wire are then connected to the adapter;

FIG. 4 is a schematic diagram of an adapter according to a further embodiment of the invention connected between an existing earphone wire kit, i.e., a hands-free kit, and the user's ear to further increase the hands-free potential and to reduce the direct radiation usually transferred by the wires in the common earphone kit;

FIGS. 5A-5E are more detailed perspective views of the embodiment of FIG. 4;

FIGS. 6A-6B are perspective views of an adapter according to a further embodiment of the invention connected between an existing earphone wire kit, i.e., a hands-free kit, and the user's ear to further increase the hands-free potential and to reduce the direct radiation usually transferred by the wires in the common earphone kit, as embodied in a headset telephone design;

FIGS. 7A-7E are more detailed perspective views of the embodiment of FIGS. 6A-6B;

FIGS. 8A-8B are two views, from different angles, of an adapter according to a further embodiment of the invention connected between an existing earphone wire kit, i.e., a hands-free kit, and the user's ear—this embodiment showing an ergonomic design and an apparatus to amplify the voice or other sound signal via use of an acoustical amplification cavity;

FIG. 9 shows the device according to the embodiment of FIGS. 8A-8B in use with a cellular telephone and further showing the earpiece; and

FIGS. 10A-10D shows additional schematic views of the embodiment of FIG. 9.

### DETAILED DESCRIPTION OF THE PREFERRED EMBODIMENTS

In the description below, the term “cellular handset” is used generically to mean any type of electrical or electronic device that is, as part of normal use, held to a portion of a user's body, and which may then cause damage in part due to emitted electromagnetic radiation.

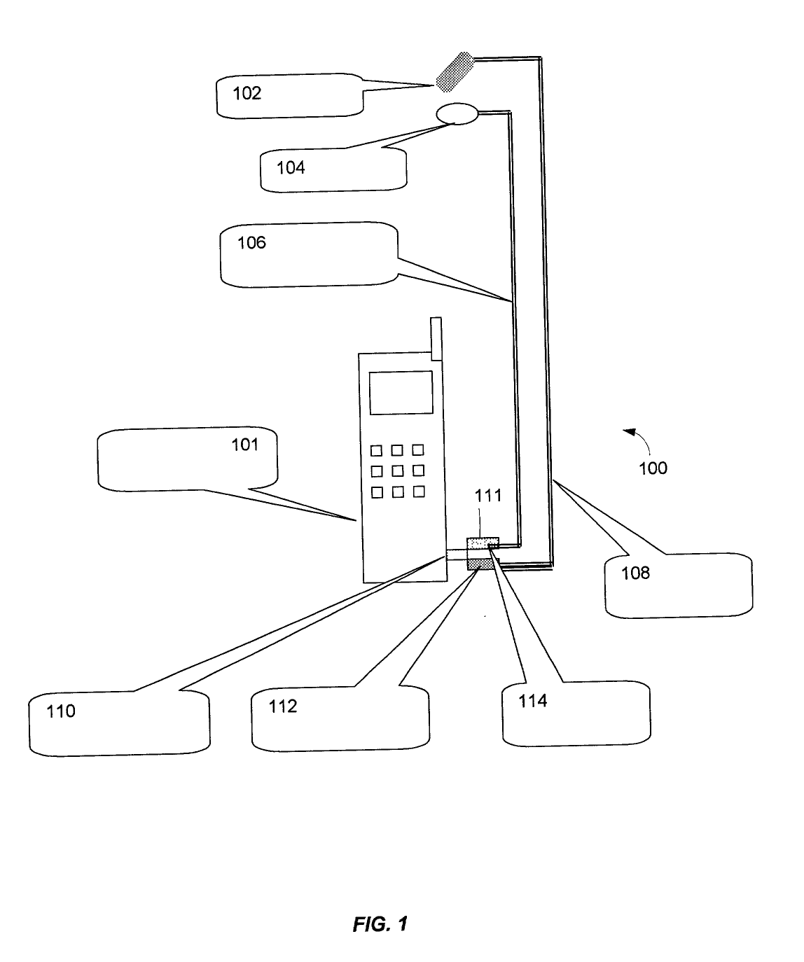

Referring to FIG. 1, showing a schematic diagram of a radiation-reducing adapter 100 connected to a cellular handset 101 according to an embodiment of the present invention, a set of two tubes 106 and 108 are connected to the adapter 100; one for each direction of transmitted voice or sound. In FIG. 1, a mini-speaker/microphone box 111 is shown coupled to a cellular hands-free jack 110. The mini-speaker/microphone box 111 includes a mini-speaker 112 and a microphone 114, which may physically be separate or combined in the same physical box. Hollow tubes 106 and 108 emerge from the microphone 114 and mini-speaker 112, respectively, and terminate at a user earpiece 102 and a user microphone 104.

The above embodiment provides for a separation of the electronics from the user so that activities may be performed in a safe fashion while using the cellular telephone. In addition, this embodiment has the safety of having the electronics of both the microphone and the speaker physically separated from the user.

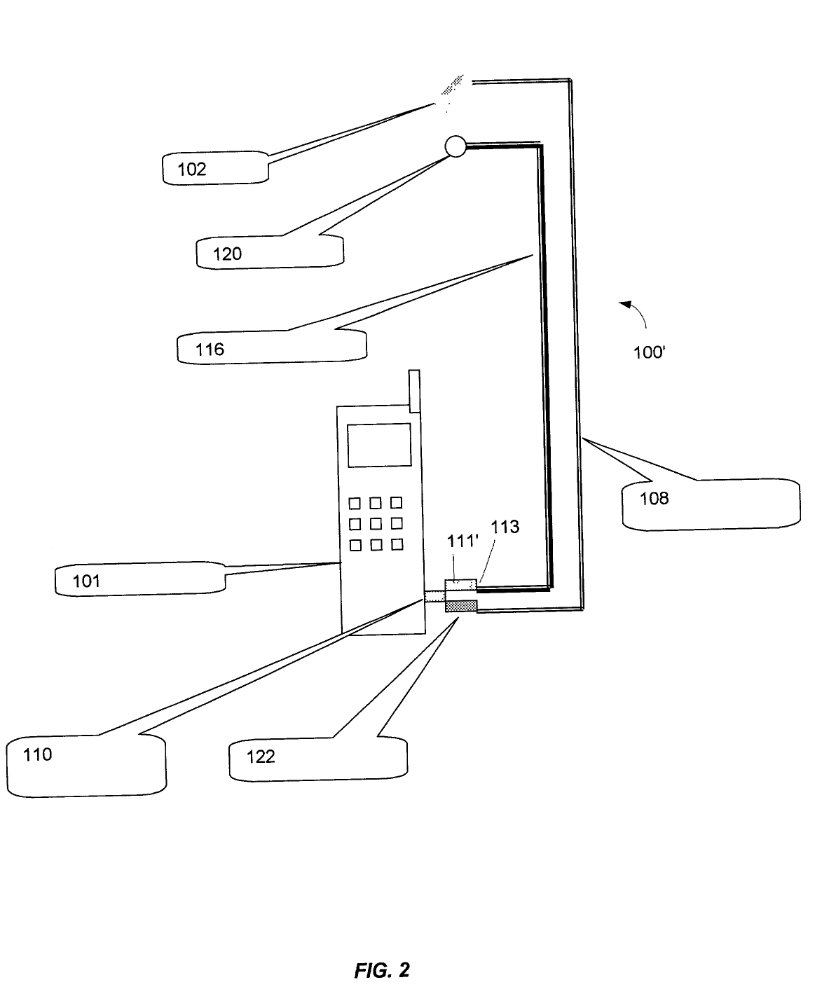

Referring to FIG. 2, another embodiment of a radiation-reducing adapter 100′ is shown having a mini-speaker/microphone box 111′ coupled to a cellular hands-free jack 110. The mini-speaker/microphone box 111′ includes a mini-speaker 122 and a port 113 for a microphone wire 116, which in turn terminates at a microphone 120. In this embodiment, hollow tube 106 is not employed. The remainder of the system is similar to that described with respect to FIG. 1.

The above embodiment also provides for a separation of the electronics from the user so that activities may be performed in a safe fashion while using the cellular telephone. Further, this embodiment has the safety of having the electronics of at least the speaker physically separated from the user.

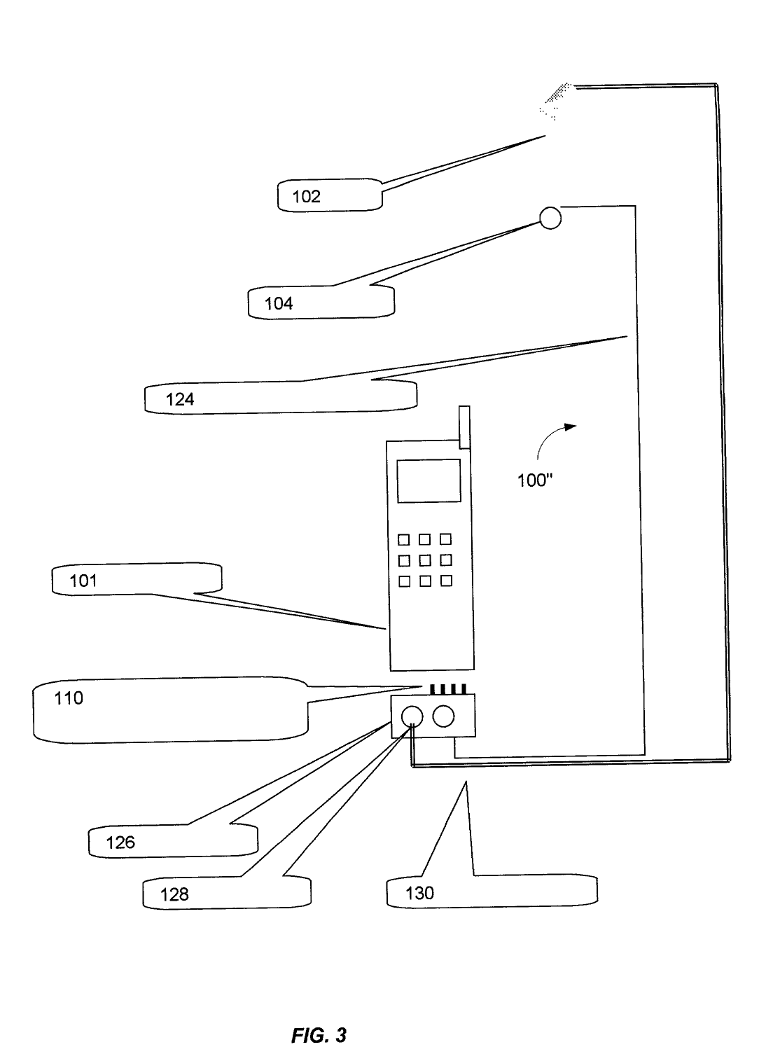

Referring to FIG. 3, a more elaborate radiation-reducing adapter 100″ is shown in which a micro-controller amplifier 126 is coupled to the cellular hands-free jack 110. In this embodiment, two tubes for transmitting sound 124 and 130 emerge from the micro-controller amplifier 126 and terminate at the user earpiece 102 and the user microphone 104. The micro-controller amplifier 126 may include function keys 128 for performing various functions such as volume control, etc.

The above embodiment also provides for a separation of the electronics from the user so that activities may be performed in a safe fashion while using the cellular telephone. This embodiment, like that of FIG. 1, has the safety of having the electronics of both the microphone and the speaker physically separated from the user.

As noted above, using a cellular telephone earphone or other “hands-free kit” can potentially create damage to the human body as radiation may be transferred from the earphone wire or microphone wire to the user brain, etc.

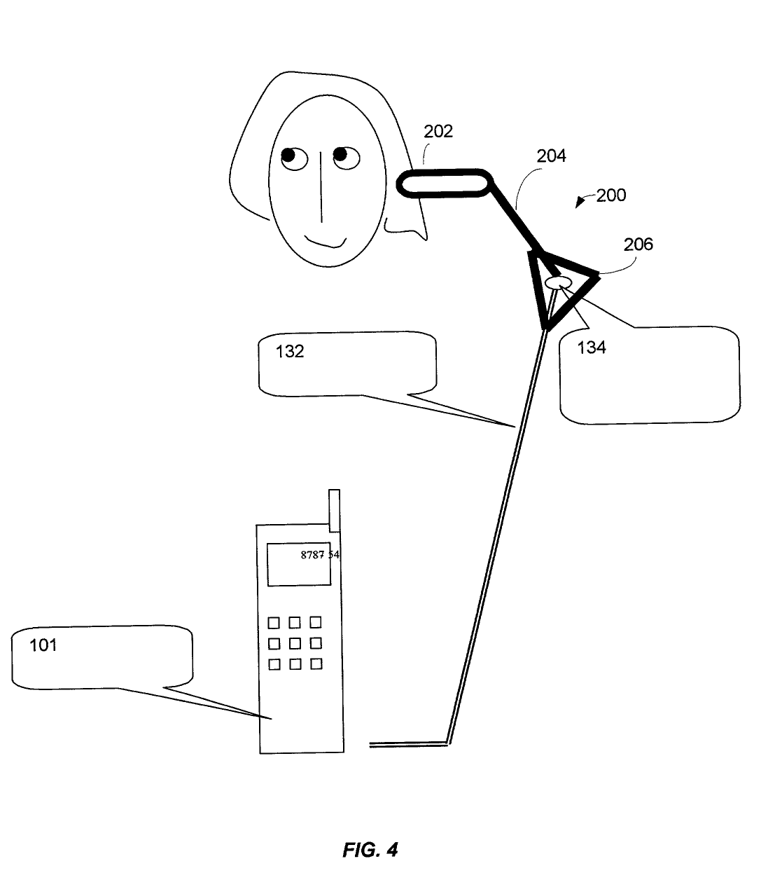

Referring to FIG. 4, a schematic diagram of a radiation-reducing adapter 200 is shown. Adapter 200 is coupled to a cellular telephone hands-free kit 132 having a terminus 134. Cellular telephone hands-free kit 132 having a terminus 134 is known. Terminus 134 may include both a microphone (not shown) and a speaker (not shown) as is known. More details of the connection of adapter 200 to cellular telephone hands-free kit 132 and more particularly to terminus 134 are disclosed below.

The above embodiment provides for a separation of the electronics from the user so that activities may be performed in a safe fashion while using the cellular telephone. This embodiment, like that of FIGS. 1 and 3, also has the safety of having the electronics of both the microphone and the speaker physically separated from the user, where in this case the separation via the sound tube is employed to reduce the direct radiation usually transferred by the wires in the common earphone kit.

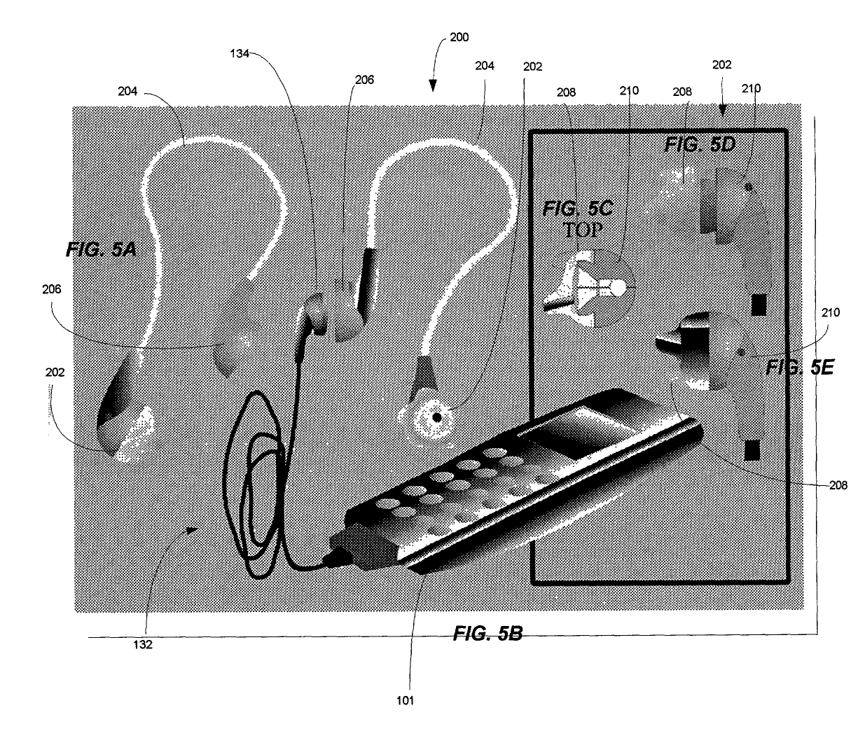

Referring to FIGS. 5A-5E showing more detailed perspective views of the embodiment of FIG. 4, a radiation-reducing adapter 200 is shown including a user earpiece 202, and sound tube 204, and a boot 206. The boot 206 acoustically couples to an earpiece 134 of the hands-free kit 132 as described in more detail below. As may be seen in most detail in FIGS. 5C-5E, the user earpiece 202 may be of a composite form, and may include an ergonomic ear-conforming member 208 which rotatably mounts to a sound tube terminus 210. The same may also mount via a friction fit or other technique as appropriate. The ear-conforming member 208 may rotate relative to the sound tube terminus 210 so that either ear may be accommodated according to the dictates of the user. It should be noted that while the above is shown for the speaker side, a similar set or components with appropriate termination may be used for the microphone or input side.

The ear-conforming member may include a suitable acoustical cavity, such as a single cavity or a double cavity wherein the cavities are separated by an orifice, such as is described below with respect to the boot 206, to amplify the sounds or voice prior to the same entering the ear canal of the user.

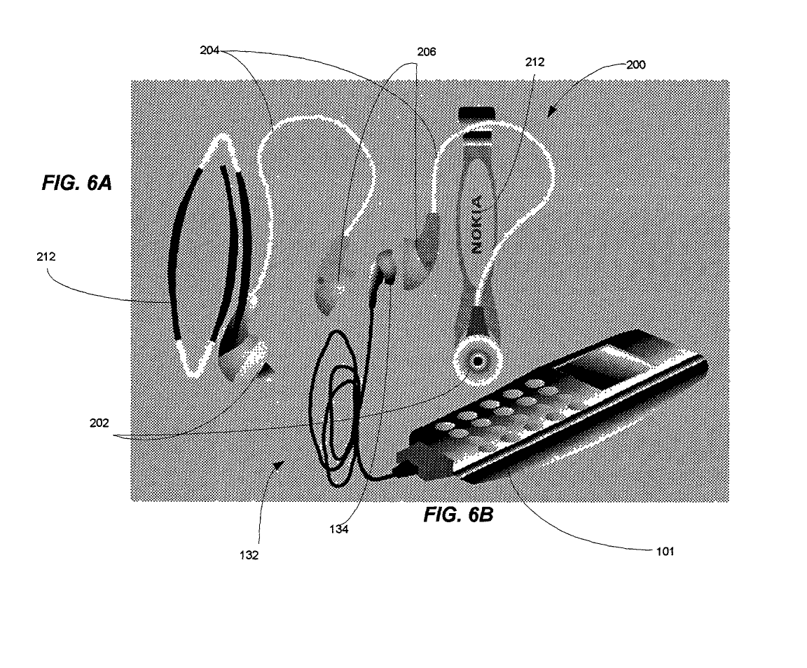

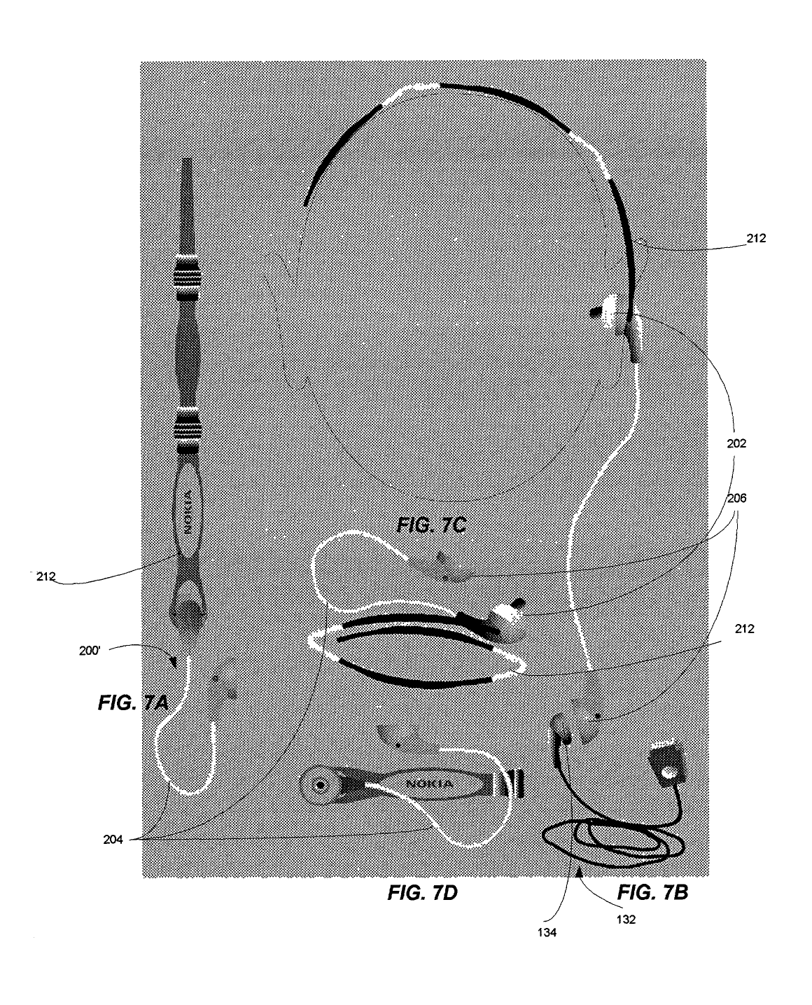

Referring to FIGS. 6A-6B showing perspective views of an adapter according to a further embodiment of the invention, an adapter 200′ is connected between an existing earphone wire kit 132, i.e., a hands-free kit, and the user's ear. In the embodiment of adapter 200′, a headset 212 is employed to fix the radiation-reducing adapter 200′ to the user's head. The same may be done for comfort, ease of use, to maintain a fixed microphone distance, or any other purpose as required by the user. FIGS. 7A-7E show more detailed perspective views of the embodiment of FIGS. 6A-6B.

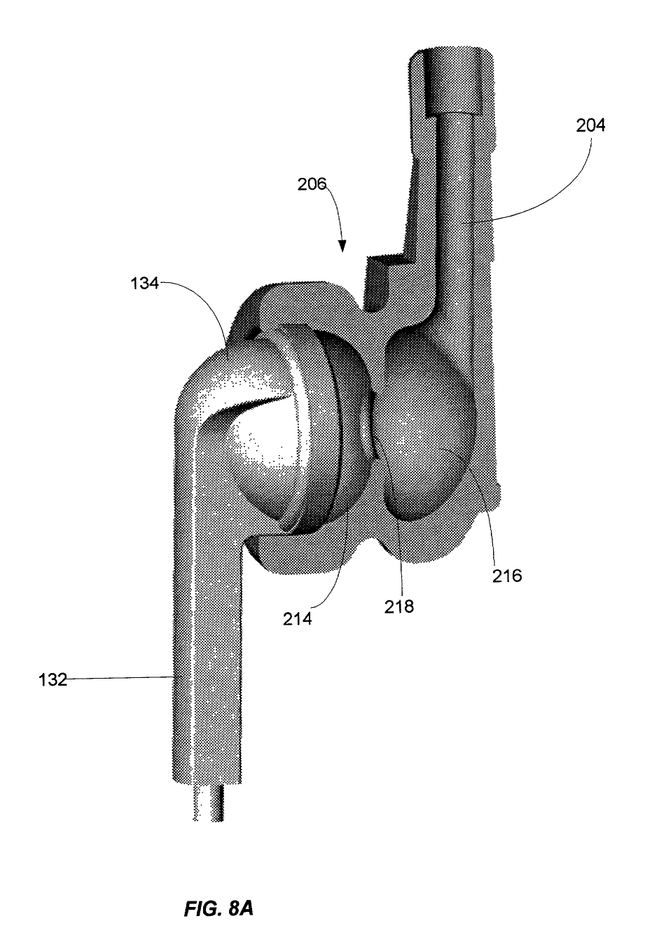

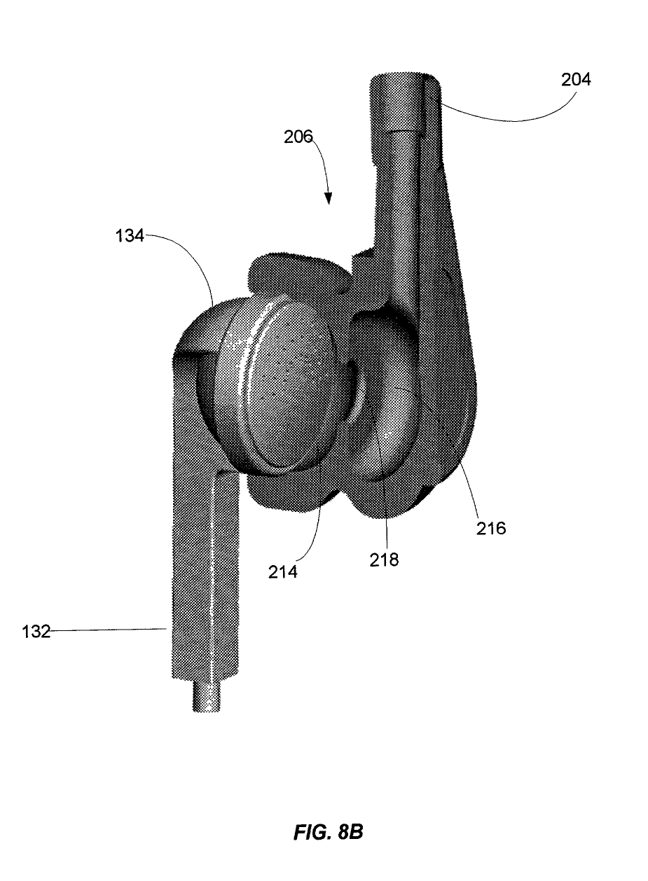

Referring to FIGS. 8A-8B showing two views, from different angles, of a boot 206 according to a further embodiment of the invention, the boot 206 is connected between an existing earphone wire kit 132, i.e., a hands-free kit, having terminus 134, and the sound tube 204. The boot 206 employs a compliant sleeve 211 into which the earphone of a hands-free kit may be inserted.

The boot 206 may employ a single acoustical drum system having a cavity, or a double acoustical drum system having two cavities—a first cavity 214 and a second cavity 216—separated by a constriction 218, which may also be a membrane. The membrane could also form a portion of the acoustical cavity or may be part of a separate item produced from plastic or metal. While the inventors do not wish to be limited by theory, the function of the dual drum system is believed that of an acoustical resonator to increase the overall sound volume sent up tube 204. This may be important in situations where the sound quality and/or volume would suffer or be attenuated by the travel up sound tube 204 to the user earpiece 202.

It is noted that the double cavity design may be replaced with a single cavity one, although the amplification effect may be less. For example, the size of orifice or constriction 218 may be up to or as large as the diameter of either of cavities 214 or 216.

Additional factors, such as the diameter of the sound tube relative to the size of the cavities and/or orifice, as well as suitable radii of curvature from the sound tube to the earpieces or boot, may be considered to increase the efficiency of the device.

For example, the ratio of the volumes of the acoustical cavity in the ear-conforming member to those in the boot may be employed to adjust the volume increase due to acoustical amplification. Such gain or amplification may be employed to increase the volume necessary for a person who is hard of hearing, for example. The same may be used to bring certain communications media up to standards as may be dictated by the ADA, either currently or in the future.

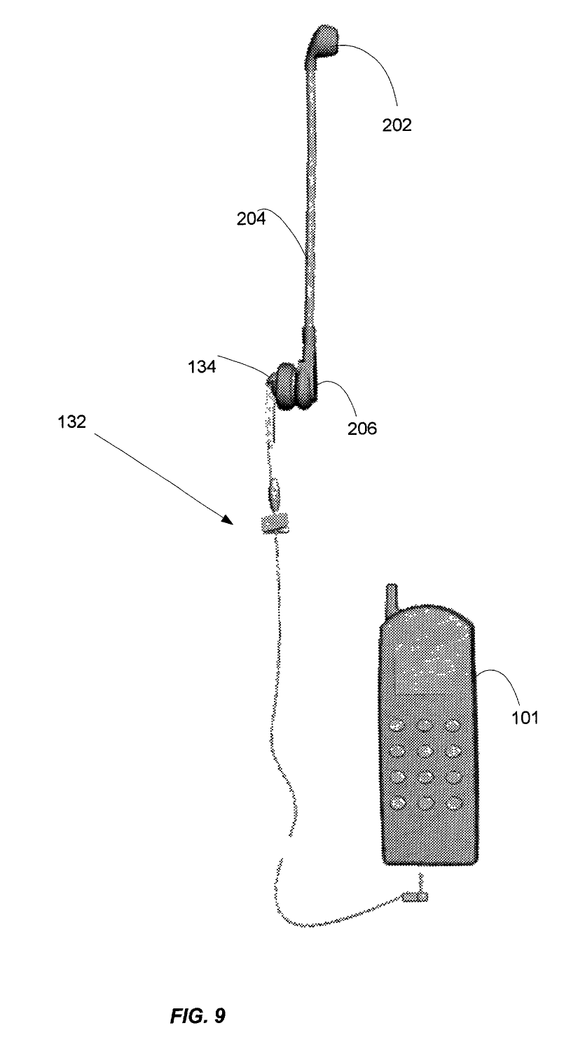

Referring to FIG. 9, the overall device according to the embodiment of FIGS. 8A and 8B may be seen in use with a cellular phone 101 and a hands-free kit 132.

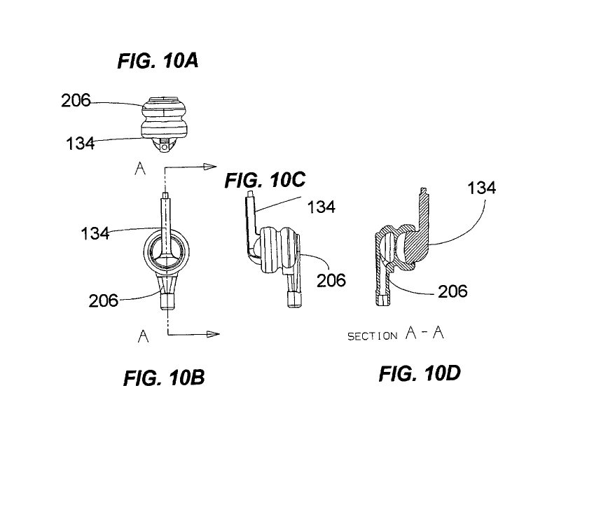

Referring to FIGS. 10A-10D showing additional schematic views of the embodiment of FIG. 9, and in particular FIG. 10D, the earpiece 134 of the hands-free kit is shown inserted within boot 206. It is noted here that boot 206 may be constructed of a suitably compliant material so as to allow a good friction fit of earpiece 134 within. Such materials may include: polyethylene, polyurethane, rubber, etc., and other such materials of similar compliancy.

It will be understood that the above description of an apparatus for minimizing radiation from electrical handsets, such as from cellular telephone handsets or hands-free kits, has been with respect to particular embodiments of the invention. While this description is fully capable of attaining the objects of the invention, it is understood that the same is merely representative of the broad scope of the invention envisioned, and that numerous variations of the above embodiments may be known or may become known or are obvious or may become obvious to one of ordinary skill in the art, and these variations are fully within the broad scope of the invention. Accordingly, the scope of the invention is to be limited only by the claims appended hereto, and equivalents thereof. In these claims, a reference to an element in the singular is not intended to mean “one and only one” unless explicitly stated. Rather, the same is intended to mean “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present invention is intended to be dedicated to the public regardless of whether the element, component, or method step is explicitly recited in the claims. No claim element herein is to be construed under the provisions of 35 U.S.C. §§112, ¶6, unless the element is expressly recited using the phrase “means for”.

What is claimed is:

1. An adaptor for enhancing safety during usage of a mobile communications unit, comprising:
an adaptor box including a plug to insert in an input/output port of a mobile communications unit;
a sound tube acoustically coupled to the adaptor box; and
a communications port acoustically coupled to the sound tube, wherein the communications port is selected from the group consisting of:
a microphone port and a speaker port.

2. The adaptor of claim 1, wherein the communications port is a speaker port, and further comprising:
another sound tube acoustically coupled to the adaptor box; and
a communications port acoustically coupled to the another sound tube, wherein the communications port is a microphone port and a speaker port.

3. The adaptor of claim 1, wherein the communications port is a speaker port, and further comprising:
A microphone wire coupled to the adaptor box; and
a microphone coupled to the microphone wire.

4. An adaptor for enhancing safety during usage of a mobile communications unit, comprising:
A microcontroller amplifier including a plug to insert in an input/output port of a mobile communications unit;
a sound tube acoustically coupled to the microcontroller amplifier; and
a communications port acoustically coupled to the sound tube, wherein the communications port is selected from the group consisting of:
a microphone port and a speaker port.

5. The adaptor of claim 4, wherein the communications port is a speaker port, and further comprising:
another sound tube acoustically coupled to the microcontroller amplifier; and
a communications port acoustically coupled to the another sound tube, wherein the communications port is a microphone port and a speaker port.

6. A method for enhancing safety during usage of a mobile communications unit using an adaptor, comprising:
providing an adaptor box, the adaptor box having:
a sound tube acoustically coupled to the adaptor box; and
a communications port acoustically coupled to the sound tube, wherein the communications port is selected from the group consisting of:
a microphone port and a speaker port; and
plugging the adaptor box into an input/output port of a mobile communications unit.

7. An adaptor for enhancing safety during usage of a mobile communications unit or a hands-free kit of a mobile communications unit, comprising:
a boot with a sleeve in which the earphone of a hands-free kit may be inserted;
a sound tube acoustically coupled to the boot; and
an earpiece acoustically coupled to the sound tube.

8. The adaptor of claim 7, wherein the boot includes a acoustical cavity for improving the quality of or increasing the volume of sound exiting the earphone and entering the sound tube.

9. The adaptor of claim 8, wherein the acoustical cavity is a single cavity.

10. The adaptor of claim 9, wherein the acoustical cavity includes a first cavity separated from a second cavity by an orifice.

11. The adaptor of claim 9, wherein the orifice has a size that is a percentage of the diameter of the first or second cavity.

12. The adaptor of claim 8, wherein the boot is made of a compliant material.

13. The adaptor of claim 12, wherein the compliant material is a polymer.

14. The adaptor of claim 7, wherein the earpiece includes a acoustical cavity for improving the quality of or increasing the volume of sound.

15. The adaptor of claim 14, wherein the acoustical cavity is a single cavity.

16. The adaptor of claim 8, wherein the earpiece includes a acoustical cavity for improving the quality of or increasing the volume of sound.

17. The adaptor of claim 16, wherein the acoustical cavity is a single cavity.

18. A method for enhancing safety during usage of a mobile communications unit or a hands-free kit of a mobile communications unit, comprising:
Providing a boot with a sleeve in which an earphone of a hands-free kit may be inserted;
Providing a sound tube acoustically coupled to the boot;
Providing an earpiece acoustically coupled to the sound tube; and
Inserting an earphone of a hands-free kit into the sleeve of the boot.

19. The adaptor of claim 8, wherein the acoustical cavity includes a membrane.

20. The adaptor of claim 19, wherein the membrane is made from a material selected from the group consisting of:
metal and plastic.
